(19) United States
(12) Patent Application Publication
(10) Pub. No.: US 2017/0048116 A1
(43) Pub. Date: Feb. 16, 2017

(54) Method And Systems To Reduce Filter Engine Rules For Network Packet Forwarding Systems

(71) Applicant: IXIA, Calabasas, CA (US)

(72) Inventor: Michael R. Anderson, Austin, TX (US)

(21) Appl. No.: 14/824,138

(22) Filed: Aug. 12, 2015

(51) Int. Cl. H04L 12/26; H04L 12/741; H04L 12/935

(52) U.S. Cl. CPC H04L 43/028; H04L 49/30; H04L 45/74

(57) ABSTRACT

Methods and systems to reduce filter engine rules for network packet forwarding systems are disclosed. In part, the disclosed embodiments process packet filters to identify certain properties which, if present, allow for techniques to be applied to avoid generating rules that do not contribute to the real-time operation of the packet forwarding system. For example, generation of filter engine rules for user-defined filters involving overlapping and mutually exclusive filter conditions are streamlined within a packet forwarding system by removing filter expressions that are not useful, such as unnecessary expressions and redundant expressions. By identifying and removing such not useful expressions, the disclosed embodiments reduce the time required to generate filter engine forwarding rules, reduce the resulting space required to store the these rules, and potentially allow increases in the numbers and complexities of packet filters applied to network packets to be forwarded by a packet forwarding system.

### TECHNICAL FIELD OF THE INVENTION

This invention relates to managing network packets and providing visibility for network packet communication systems.

### BACKGROUND

Packet-based data networks continue to grow in importance, and it is often desirable to monitor network traffic associated with these packet-based networks on an ongoing basis. To meet these monitoring needs, copies of network packets can be forwarded to diagnostic network monitoring tools. Packets are often forwarded using network hubs, test access ports (TAPs), and/or switched port analyzer (SPAN) ports available on network switch systems. For example, certain network switch systems produced by Cisco Systems include SPAN ports to which traffic on the switches are mirrored. It is also noted that other packet monitoring or access methods may also be used to acquire copies of network packets being communicated within a network infrastructure.

To help alleviate the problem of limited access to network packets for monitoring, tool aggregation devices or packet broker devices have been developed that allow shared access to the monitored network packets. These tool aggregation devices allow users to obtain packets from one or more network monitoring points (e.g., network hub, TAP, SPAN port, etc.) and to forward them to different monitoring tools. U.S. Pat. No. 8,018,943, U.S. Pat. No. 8,098,677, and U.S. Pat. No. 8,934,495 describe example embodiments for network tool optimizer systems that provide packet forwarding systems for tool aggregation and packet broker solutions and describe in part configuration of user-defined filters, automatic creation of filter engine forwarding rules, automatic handling of filter overlaps, graphical user interfaces (GUIs) for filter creation, and other features. U.S. Published Patent Application Number 2014/0254396 describes in part example embodiments for multiple packet forwarding systems that are combined into a unified packet forwarding system. U.S. Pat. No. 8,018,943, U.S. Pat. No. 8,098,677, U.S. Pat. No. 8,934,495, and U.S. Patent Number 2014/0254396 are each hereby incorporated by reference in its entirety.

One basic approach to generate filter engine forwarding rules for user-defined filters is to generate every possible filter engine forwarding rule for the user-defined filters. However, under some conditions, such as overlapping filters, the number of possible filter engine forwarding rules can be extremely large. A filter processor attempting to generate such an extremely large set of possible filter engine forwarding rules can require a significant amount of time and a significant amount of system memory to generate and store such an extremely large set of possible filter engine forwarding rules. When this rule generation requires many hours or days to complete, the performance of the packet forwarding system is degraded, as a user or manager of the packet forwarding system is not able to implement desired user-defined filters.

One prior technique has attempted to address this problem by looking for filters that contain exactly one non-intersecting criterion representing distinct variables from a single class. However, this prior technique does not apply to many combinations of user-defined filters that can cause extremely long undesirable delays in generating filter engine forwarding rules. Another rule reduction technique is described in U.S. Published Patent Application No. 2014/0254396 where layered truth tables are used to reduce filter rules.

### SUMMARY OF THE INVENTION

Methods and systems to reduce filter engine rules for network packet forwarding systems are disclosed. The disclosed embodiments process packet filters to identify certain properties which, if present, allow for techniques to be applied to avoid generating packet forwarding rules that will not contribute to the real-time operation of the packet forwarding system. In part, the disclosed embodiments recognize that filters require certain properties to generate useful expressions for filter rules and provide techniques to identify these properties. For example, generation of filter engine forwarding rules for user-define filters involving overlapping filter conditions and mutually exclusive filter conditions are streamlined within a packet forwarding system by removing filter expressions that are not useful, such as unnecessary expressions and redundant expressions. By identifying and removing such not useful expressions, the disclosed systems and methods reduce the time required to generate filter engine forwarding rules, reduce the resulting space required to store the these rules, and potentially allow increases in the numbers and complexities of packet filters applied to network packets to be forwarded by a packet forwarding system. Other features and variations can also be implemented, if desired, and related systems and methods can be utilized, as well.

For one embodiment, a method to control forwarding of network packets is disclosed including storing a plurality of filters within a packet forwarding system, each filter being configured to determine how packets are forwarded by the packet forwarding system; processing the filters to identify overlapping conditions and mutually exclusive conditions; removing, when overlapping conditions or mutually exclusive conditions are found, unnecessary expressions and redundant expressions to form a set of reduced filter expressions for the plurality of filters; generating rules for one or more filter engines based upon the set of reduced filter expressions for the plurality of filters; applying the rules to the one or more filter engines within the packet forwarding system; receiving packets from a network using the packet forwarding system; and forwarding the received packets using the filter engines within the packet forwarding system so that packets are forwarded based upon the plurality of filters.

In another embodiment, the processing includes generating subsets of filters based upon the plurality of filters and analyzing each subset of filters to identify duplicated filter expressions. In a further embodiment, the method includes, for each subset of filters, removing duplicated filter expressions as redundant expressions. In a still further embodiment, the method includes generating rules for each subset of filters after duplicated filter expressions are identified and removed as redundant expressions.

In another embodiment, the processing includes, for each of the plurality of filters, pairwise comparing the filter to each of the other filters to identify filter expression contradictions. In a further embodiment, the method includes, for each filter, saving the filter to a reduced set of filters if no filter expression contradictions were identified from the pairwise comparison. In a still further embodiment, the method includes generating rules for the reduced set of filters once all filters have been pairwise compared.

In another embodiment, the method includes allowing user configuration of the plurality of filters through a user interface. In a further embodiment, the method includes receiving packets from one or more network sources coupled to one or more input ports for the packet forwarding system, forwarding packets within the packet forwarding system from the one or more input ports to one or more output ports using the one or more filter engines, and forwarding packets from one or more output ports for the packet forwarding system to one or more network destinations. In a still further embodiment, the one or more filter engines include one or more ingress filter engines associated with input ports for the packet forwarding system and one or more egress filter engines associated with output ports for the packet forwarding system.

For one embodiment, a packet forwarding system for network packets is disclosed that includes a plurality of input ports to receive network packets; a plurality of output ports to output network packets; a plurality of filter engines that determine how network packets are forwarded from the input ports to the output ports within the packet forwarding system based upon filter engine rules; a plurality of filters to define how packets from the input ports are to be forwarded to the output ports; and a filter processor to receive the plurality of filters and to process the filters to identify overlapping conditions and mutually exclusive conditions; to remove, when overlapping conditions or mutually exclusive conditions are found, unnecessary expressions and redundant expressions to form a set of reduced filter expressions for the plurality of filters; to generate the filter engine rules for the filter engines based upon the filters; and to apply the rules to the filter engines.

In another embodiment, the filter processor is configured to generate subsets of filters based upon the plurality of filters and to identify duplicated filter expressions for each subset of filters. In a further embodiment, the filter processor is further configured, for each subset of filters, to remove duplicated filter expressions as redundant expressions. In a still further embodiment, the filter processor is further configured to generate rules for each subset of filters after duplicated filter expressions are identified and removed as redundant expressions.

In another embodiment, the filter processor is further configured, for each of the plurality of filters, to pairwise compare the filter to each of the other filters and to identify filter expression contradictions between the filters. In a further embodiment, the filter processor is further configured, for each filter, to save the filter to a reduced set of filters if no filter expression contradictions were identified for the filter from the pairwise comparison. In a still further embodiment, the filter processor is further configured to generate rules for the reduced set of filters once all filters have been pairwise compared.

In another embodiment, the packet forwarding system further includes a user interface for the packet forwarding system to allow configuration of the plurality of filters. In a further embodiment, the one or more filter engines include one or more ingress filter engines associated with input ports for the packet forwarding system and one or more egress filter engines associated with output ports for the packet forwarding system. In a still further embodiment, at least one of the filter processor or the plurality of filter engines includes one or more virtual machines operating within a virtual processing environment.

Different or additional features, variations, and embodiments can be implemented, if desired, and related systems and methods can be utilized, as well.

### DESCRIPTION OF THE DRAWINGS

It is noted that the appended drawings illustrate only example embodiments of the invention and are, therefore, not to be considered limiting of its scope, for the invention may admit to other equally effective embodiments.

FIG. 1 is a block diagram of an example embodiment for a network environment including a packet forwarding system having a rule reduction engine.

FIG. 2 is a process flow diagram of an example embodiment to identify filter expressions that are not useful and therefore are not used to generate the filter rules for application to the filter engines.

FIG. 3 is a process flow diagram of an example embodiment for detection of overlapping conditions and removal of not useful expressions, such as unnecessary formulas and redundant expressions, prior to generation of packet forwarding rules for the filter engines.

FIG. 4 is a process flow diagram of an example embodiment for detection of mutually exclusive conditions and removal of not useful expressions, such as unnecessary formulas and redundant expressions, prior to generation of packet forwarding rules for the filter engines.

FIG. 5A is a block diagram of an example embodiment for a packet forwarding system including a rule reduction engine.

FIG. 5B is a diagram of an example embodiment for a product configuration as well as external connections for an example packet forwarding system.

FIG. 6A is a block diagram of an example embodiment for a virtual machine (VM) host hardware system that includes virtual machine operating as a packet forwarding system.

FIG. 6B is a block diagram of an example embodiment for a server system including multiple virtual machine (VM) environments that host VM platforms implementing packet forwarding systems.

### DETAILED DESCRIPTION OF THE INVENTION

Methods and systems to reduce filter engine rules for network packet forwarding systems are disclosed. As described in more detail below, the disclosed embodiments process packet filters to identify certain properties which, if present, allow for techniques to be applied to avoid generating packet forwarding rules that will not contribute to the real-time operation of the packet forwarding system. In part, the disclosed embodiments recognize that filters require certain properties to generate useful expressions for filter rules and provide techniques to identify these properties. For example, generation of filter engine forwarding rules for user-define filters involving overlapping filter conditions and mutually exclusive filter conditions are streamlined within a packet forwarding system by removing filter expressions that are not useful, such as unnecessary expressions and redundant expressions. Further, these conditions can include filter expressions that provide: overlapping conjunctions of logical filter expressions and related parameters, negation-free conjunctions of logical filter expressions and related parameters, conjunctions of logical filter expressions and related parameters with mutually exclusive terms, and/or conjunctions of logical filter expressions and related parameters with disjoint, mutually exclusive terms. By identifying and removing such not useful expressions, the disclosed systems and methods reduce the time required to generate filter engine forwarding rules, reduce the resulting space required to store the these rules, and potentially allow increases in the numbers and complexities of packet filters applied to network packets to be forwarded by a packet forwarding system. The packet forwarding system can also be implemented in stand-alone hardware environments, in virtual processing environments, and/or in other packet processing environments or combinations of packet processing environments. Variations can also be implemented while still taking advantage of the rule reduction techniques described herein that reduce the number of filter engine rules and/or size of information required to define such filter engine rules.

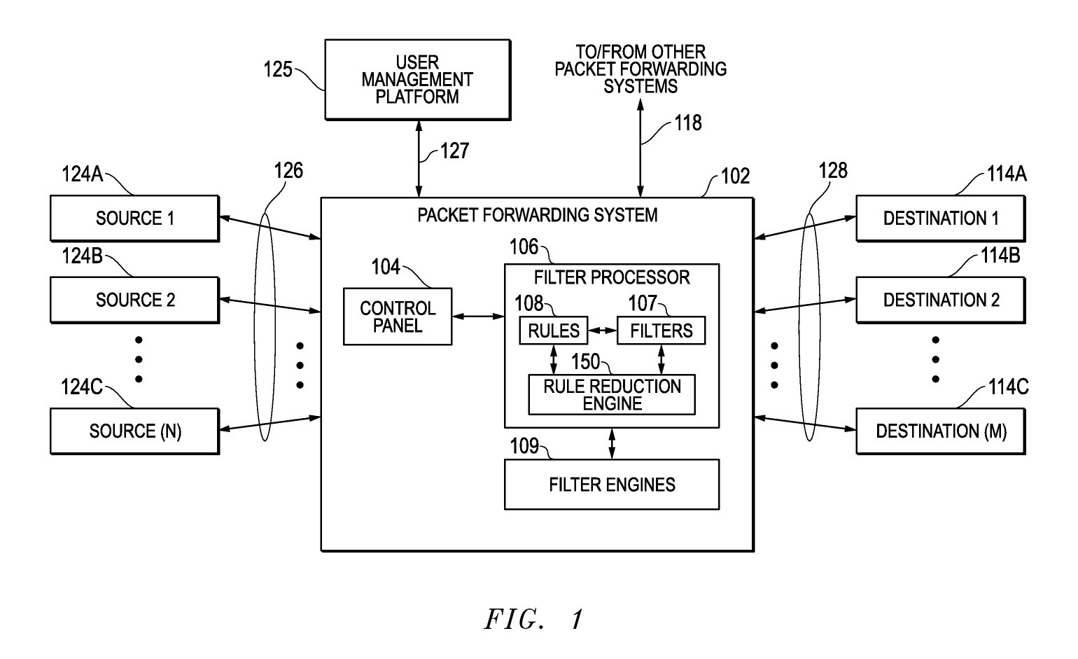

FIG. 1 is a block diagram of an example embodiment for a network environment 100 including a packet forwarding system 102 having a rule reduction engine 150. The packet forwarding system 102 receives copies of packet traffic from one or more sources 124A, 124B . . . 124C through one or more network connections 126 and forwards these packets to one or more destinations 114A, 114B . . . 114C through network connections 128 based upon filter rules 108 applied to filter engines 109. The packet forwarding system 102 allows a user or administrator to view, define and/or manage filters 107 through user management platform 125 connected to the system 102 through network connections 127. The filter processor 106 within the packet forwarding system 102 automatically generates the packet forwarding rules 108 based upon the forwarding instructions defined by the filters 107. Once generated, the packet forwarding rules 108 are applied by the filter processor 106 to filter engines 109 to determine how packets are forwarded by the packet forwarding system 102 from input ports that receive network traffic from sources 124A, 124B . . . 124C to output ports that provide packets to the destinations 114A, 114B . . . 114C. The packet forwarding system 102 also includes a control panel 104 that provides user interfaces (UI), such as graphical user interface (GUI), that can be accessed through the user management platform 125 to allow users/administrators to view, create and/or manage the filters 107. The packet forwarding system 102 can also communicate with one or more additional packet forwarding systems through network connections 118.

As described with respect to the embodiments disclosed herein, the rule reduction engine 150 is used by the filter processor 106 to process filters 107 to determine if the filters generate expressions that are not useful, such as unnecessary and/or redundant expressions. If so, these not useful expressions are removed to generate a set of reduced filter expressions. The filter processor 106 then uses this set of reduced filter expressions to generate filter engine rules 108 that are applied by the filter processor 106 to the filter engines 109. As such, the rules 108 are reduced in size and complexity as compared to prior solutions. Further, as compared to prior solutions that explicitly enumerate assignments to filter conditions in order to find satisfying ones and treat the filter conditions as independent of the combinations in which they will be used, the disclosed embodiments implicitly construct an interpretation for the filter conditions in combination as part of the process of constructing the rules set. This technique thereby allows conditions which are never satisfiable or which are logical contradictions to be avoided without need of an interpretation and related rule generation.

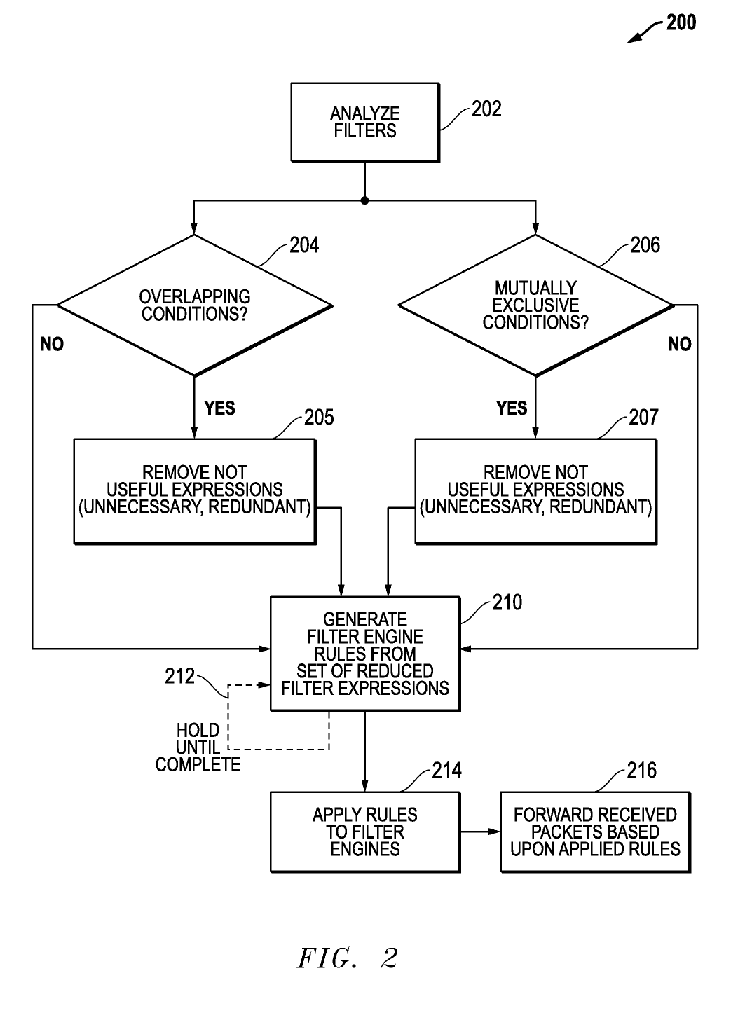

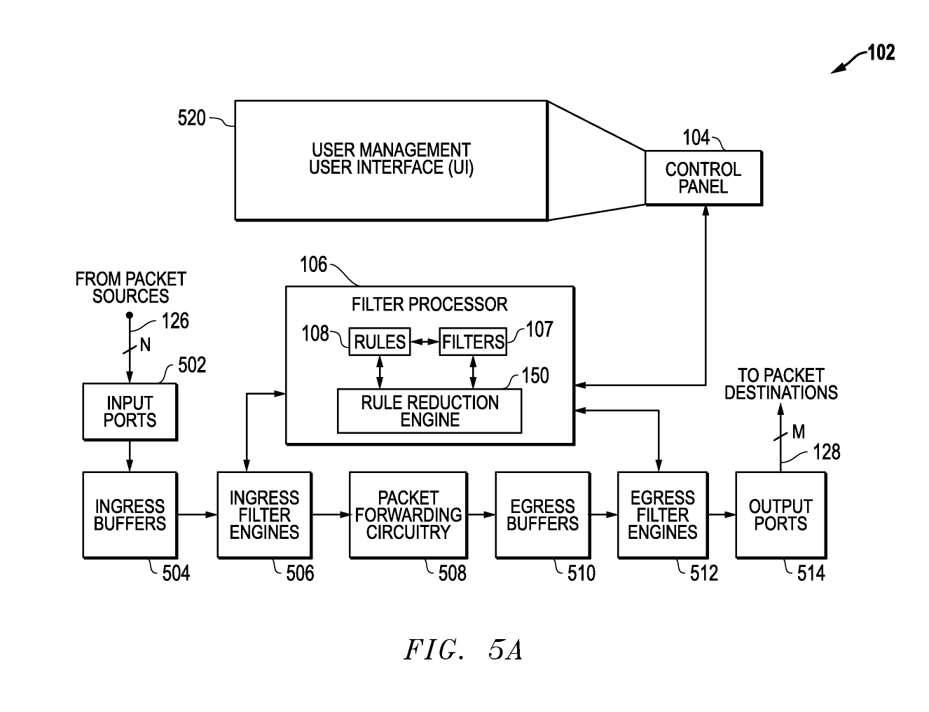

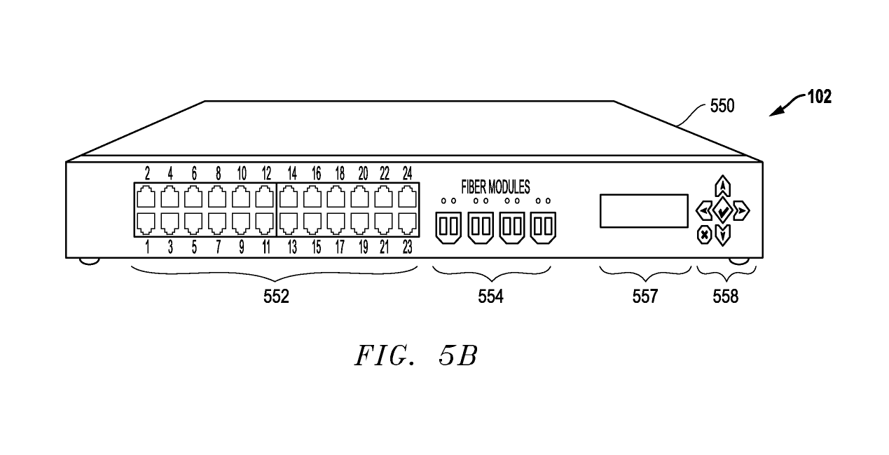

FIGS. 2-4 below provide example embodiments for process flow diagrams to identify overlapping conditions and mutually exclusive conditions within filters. If these are identified, not useful expressions are removed, and filter engine rules 108 are generated based upon a set of reduced filter expression. FIGS. 5A-B and 6A-B provide example processing environments for packet forwarding systems that utilize the rule reduction techniques described herein. Further, rule reduction examples are provided that identify and remove filter expressions that are not useful, such as unnecessary expressions and redundant expressions, within filters having overlapping and/or mutually exclusive conditions.

It is noted that network visibility solutions, such as packet forwarding system 102, include hardware, software, or combined hardware and software implementations that filter, aggregate, and/or otherwise process packets from a network and make them available to one or more monitoring tools or other devices. According to one aspect of the disclosed embodiments, a packet forwarding system, such as a network tool optimizer (NTO) or packet broker, includes one or more input ports configured to receive network traffic, such as network packets communicated through a packet-based communication network, and one or more output ports configured to provide filtered network traffic to one or more network tools or other devices. The source network traffic provided by connections 126 can be obtained through one of a variety of techniques and devices, such as for example, from network TAPs, from SPAN ports on network switches, and/or from other devices or systems that copy or otherwise obtain packets or packet contents from network traffic flows and make them available for other devices and systems. The network connections and communications described herein can include wired, wireless, and/or combinations of wired and wireless network communications among network-connected devices or systems and can include communications through one or more intervening devices or systems, such as firewalls, routers, switches, and/or other network-connected devices or systems.

It is also noted that the control panel 104 for the packet forwarding system 102 can be implemented as a web interface that can be accessed through a network browser (e.g., MICROSOFT Internet Explorer or MOZILLA Firefox) by other network-connected processing systems. For example, the packet forwarding system 102 can be configured to automatically download a control panel software application to the user management platform 125 when a network browser operating on the user management platform 125 connects to an IP address for the packet forwarding system 102. This download can occur the first time the network browser connects, and the control panel 104 can then be stored locally by the user management platform 125. The user management platform 125 can be, for example, personal computer systems, server systems, and/or other processing systems running WINDOWS operating systems, LINUX operating systems, and/or other operating system as desired. In one embodiment, the control panel 104 can in part be downloaded as JAVA-based software code or modules. Other implementations could also be implemented.

It is further noted that the network traffic sources 124A, 124B . . . 124C can include any of a wide variety of systems that are connected within a network communication system. These systems can include server systems, data storage systems, desktop computer systems, portable computer systems, network switches, broadband routers and/or any other desired processing systems that are connected into a cloud network, as desired. In addition to these systems, any number of network traffic destinations 114A, 114B . . . 114C can also be connected within the network communication system. Further, when implemented as network monitoring tools, the network traffic destinations 114A, 114B . . . 114C be can any of a wide variety of network related tools including traffic monitoring devices, packet sniffers, data recorders, voice-over-IP monitors, intrusion detection systems, network security systems, application monitors and/or any other desired network management or security tool device or system. Still further, as described herein, the sources 124A, 124B . . . 124C, the destinations 114A, 114B . . . 114C, the packet forwarding system 102, and/or the user management platform 125 can be implemented as virtual machines or instances within a virtual processing environment within a larger computing platform. It is further noted that the network communications can be based upon any desired protocol or combination of protocols including Ethernet protocols, multi-protocol label switching (MPLS) protocols, FibreChannel (FC) protocols and/or any other desired communication protocol that can be used for network communications including packet-based network communications.

Still further, it is noted that the filters 107 as well as the forwarding engine rules 108 generated by the filter processor 106 can rely upon various portions of the content of network packets for forwarding actions. For example, network packets typically include in part a link layer header (L2), a network layer header (L3), a transport layer header (L4) and a payload, as well as other network layers (e.g., layers within the Open Systems Interconnect (OSI) model for network communications). Information pertinent to forwarding the packet, such as source ID and destination ID and protocol type, is usually found in the packet headers. These packets may also have various other fields and information within them, such as fields including error check information, virtual local area network (VLAN) identifiers, and/or other information that may be matched and used for filtering. Further, information representing the source device may include items such as the IP address of the source device or the MAC (Media Access Control) address of the source device. Similarly, information representing the destination device may be included within the packet such as the IP address of the destination device. It is seen, therefore, that a wide variety of source and destination identifying information may be included within the packets as well as other packet related information along with the data included within the payload of the packet. While the packet forwarding system embodiments described herein are primarily described with respect to packet-based communications and utilize information within these packets to forward the packets, the packet forwarding system embodiments can be configured to operate with respect to other types of communication protocols and are not limited to packet-based networks.

Looking now to FIG. 2, a process flow diagram is shown of an example embodiment 200 to identify filter expressions that are not useful and therefore are not used to generate the filter rules 108 for application to the filter engines 109. In block 202, the user-defined filters 107 are analyzed. Flow then passes to both blocks 204 and 206. In block 204, a determination is made whether or not combinations of the user-defined filters include overlapping conditions. If the determination in block 204 is “YES,” then block 205 is reached where not useful expressions, such as unnecessary expressions or redundant expressions, are removed. In block 206, a determination is made whether or not the combination of the user-defined filters includes mutually exclusive conditions. If the determination in block 206 is “YES,” then block 207 is reached where not useful expressions, such as unnecessary expressions or redundant expressions, are removed. If the determination in block 204 or 206 is “NO,” then block 210 is reached. In block 210, filter engine rules 108 are generated from the set of reduced filter expressions once the removal processes in blocks 205/207 have completed. As represented by dashed line 212, the rule generation in block 210 can be held until these removal processes in blocks 205/207 have completed. Block 214 is then reached where the packet forwarding rules are applied to the filter engines. In block 216, received packets are forwarded based upon the rules that were applied to the filter engines. Advantageously, the size and/or number of rules required to be stored in the filter engines is reduced, as compared to prior solutions, based upon the rule reduction techniques provided by blocks 204, 205, 206, 207, and 210. It is further noted that additional and/or different process steps could also be included while still taking advantage of the rule reduction techniques described herein.

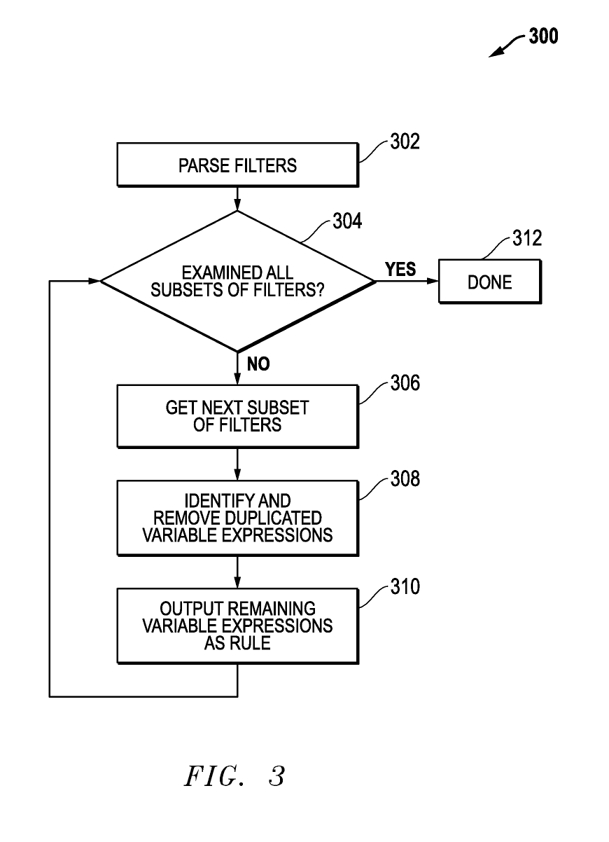

FIG. 3 is a process flow diagram of an example embodiment 300 for detection of overlapping conditions and removal of not useful expressions, such as unnecessary formulas and redundant expressions, prior to generation of packet forwarding rules 108 for the filter engines 109. In block 302, the defined filters are received and parsed to generate possible subsets of filters. In block 304, a determination is made whether all subsets of filters have been examined. If “NO,” then the process moves to block 306 where the next subset of filters is obtained. In block 308, this subset is analyzed to identify duplicated variable expressions and to remove any such identified duplicated variable expressions as redundant expressions. In block 310, the remaining variable expressions are used to generate and output filter engine forwarding rules. Flow then passes back to block 304. Once the determination in block 304 is “YES,” then the process is done and ends in block 312.

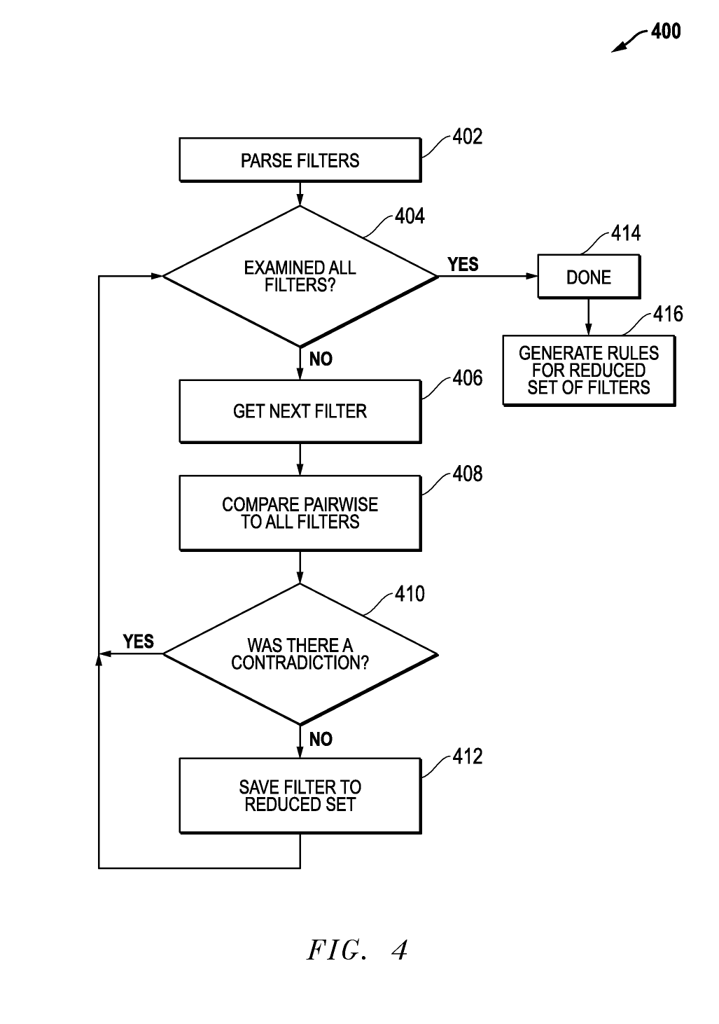

FIG. 4 is a process flow diagram of an example embodiment 400 for detection of mutually exclusive conditions and removal of not useful expressions, such as unnecessary formulas and redundant expressions, prior to generation of packet forwarding rules 108 for the filter engines 109. In block 402, the defined filters are received and parsed to identify available filters. In block 404, a determination is made whether all filters have been examined. If “NO,” then the process moves to block 406 where the next filter is obtained. In block 408, this filter is compared to each of the other filters to identify filter contradictions between each filter pair. In block 410, a determination is made whether a contradiction was identified during this pairwise comparison. If “YES,” then flow passes back to block 404 so that the filter being analyzed is effectively removed as including unnecessary expressions due to the contradictions. If “NO,” then flow passes to block 412 where the current filter is saved to a reduced set of useful filters. Flow then passes back to block 404. Once the determination in block 404 is “YES,” then the process is done and block 414 is reached. In block 416, filter engine forwarding rules are then generated for the reduced set of filters that has been saved.

It is noted that the rule reduction processing of FIG. 3 and FIG. 4 can both be applied to a set of user-defined filters in any desired order to reduce the number of filter rules that are generated for the set of user-defined filters. It is also noted that additional and/or different process steps could also be used while still taking advantage of the rule reduction techniques described herein.

Now looking to FIG. 5A, a block diagram is provided for an example embodiment of a packet forwarding system 102 including a rule reduction engine 150. As described with respect to FIG. 1, the packet forwarding system 102 includes a control panel 104 that provides management access to a user management platform 125. The control panel 104 in part provides a user management user interface (UI) 520 through which a user can define, manage, and control the filters 107. The filter processor 106 for the packet forwarding system 102 processes the filters 107 using the rule reduction engine 150 and then generates forwarding rules 108 for filter engines 109. For the embodiment of FIG. 5A, the filter engines 109 are implemented as ingress filter engines 506 and egress filter engines 512, and filter processor 106 applies the forwarding rules 108 to the filter engines 506/512.

In operation, the forwarding rules 108 determine at least in part how the filter engines 506/512 forward packets from input ports 502 to output ports 514 for the packet forwarding system 102 through packet forwarding circuitry 508. The packet forwarding circuitry 508 forwards packets between input ports 502 and output ports 514 based in part upon the forwarding rules 108 set up in the ingress filter engines 506 and the egress filter engines 512. For the embodiment depicted, packets from connections 126 are received at the input ports 502. These packets are then stored in ingress queues or buffers 504 prior to being processed by ingress filter engines 506. Based upon ingress filter rules within the ingress filter engines 506, the packet forwarding circuitry 508 forwards packets to the appropriate output ports 514. However, prior to being sent out through the output ports 514 to external systems, the outgoing packets are first stored in egress queues or buffers 510 and then processed by egress filter engines 512. Based upon egress filter rules within the egress filter engines 512, the egress filter engines 512 forward the appropriate packets to the output ports 514. The output ports 514 are connected to destinations, such as network tools, through connections 128. The filter processor 106 communicates with the ingress filter engines 506 and egress filter engines 512 to apply the forwarding rules 108 so that these filter engines 506/512 will provide the packet forwarding defined by the user filters 107.

It is noted that the packet forwarding system 102 can be implemented using one or more network packet switch integrated circuits (ICs), such as are available from Broadcom Corporation. These switch integrated circuits include input port circuitry, ingress buffer circuitry, ingress filter engine circuitry, switch fabric packet forwarding circuitry, egress buffer circuitry, egress filter engine circuitry, output port circuitry, internal processors and/or other desired circuitry. Further these integrated circuits can include control and management interfaces through which they can be programmed to provide desired forwarding and control. As such, the filter processor 106 can program the filter engines within the network packet switch integrated circuit with appropriate forwarding rules. The packet forwarding system 102 can also include other circuitry and components, as desired. For example, packet forwarding system 102 can include one or more printed circuit boards (PCBs) upon which the network packet switch IC is mounted, power supply circuitry, signal lines coupled to external connections, and a variety of external connectors, such as Ethernet connectors, fiber optic connectors or other connectors, as desired. It is further noted that the packet forwarding system 102 including the filter processor 106 can be implemented using one or more programmable processing devices. For example, the network packet switch ICs can be controlled and operated using a processor, microcontroller, configurable logic device (e.g., CPLD (complex programmable logic device), FPGA (field programmable gate array)), and/or other processing device that is programmed to control these integrated circuits to implement desired functionality. It is further noted that software or other programming instructions used for the packet forwarding system 102 and/or its components, such as filter processor 106 and the control panel 104, can be implemented as software or programming instructions embodied in a non-transitory computer-readable medium (e.g., memory storage devices, FLASH memory, DRAM memory, reprogrammable storage devices, hard drives, floppy disks, DVDs, CD-ROMs, etc.) including instructions that cause processing devices used by the packet forwarding system 102 to perform the processes, functions, and/or capabilities described herein.

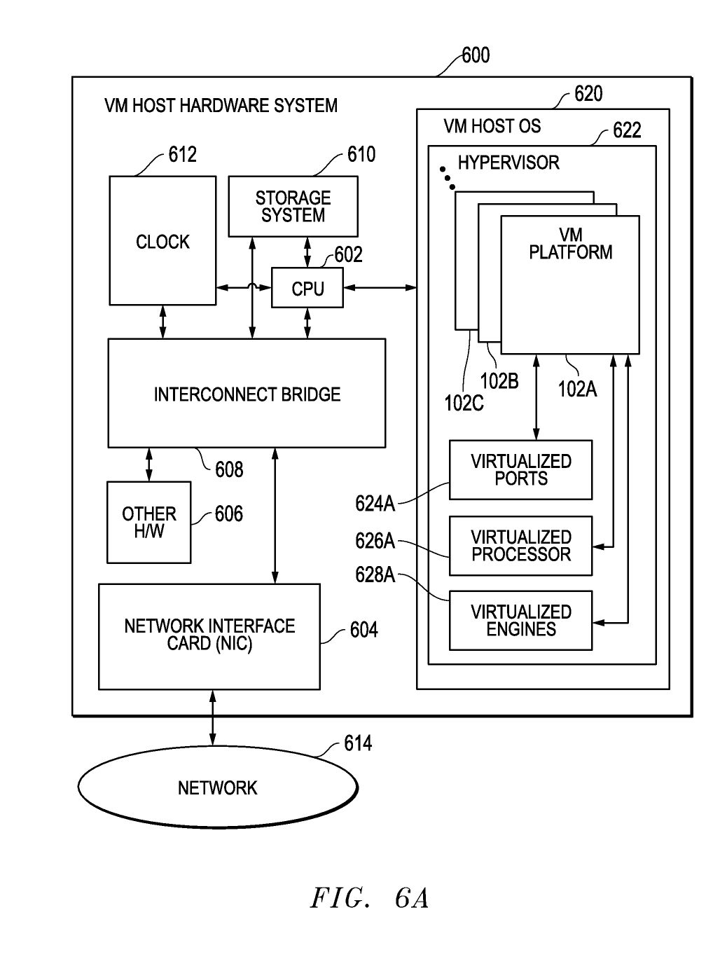

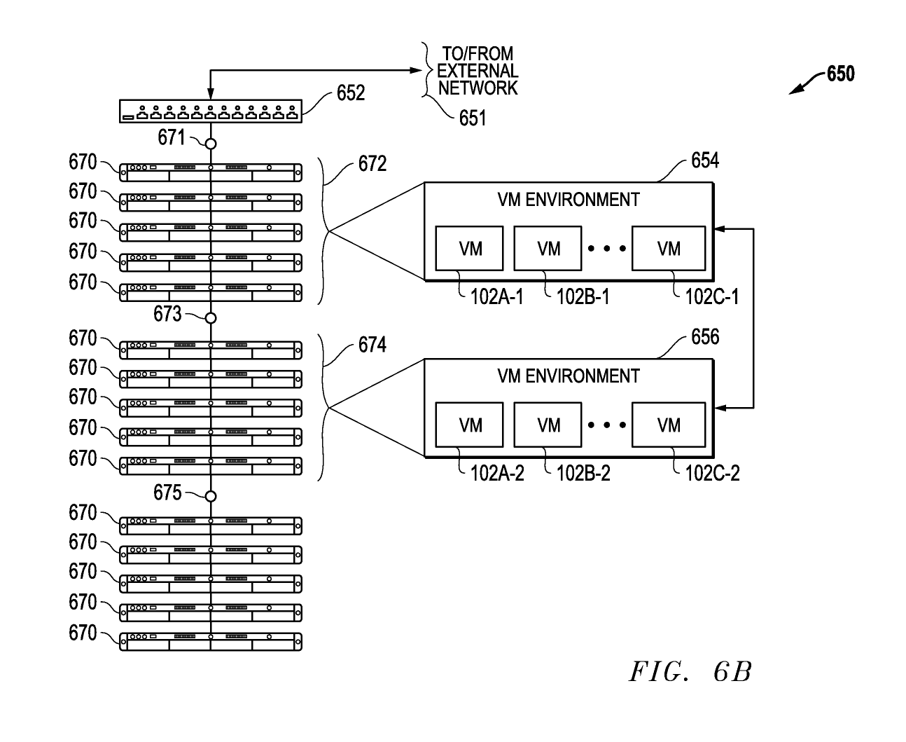

In one embodiment for the packet forwarding system 102, a PCB can include a processor IC separate from a network packet switch IC. The filter processor 106 including the rule reduction engine 150 can then be configured to operate on the separate processor IC, and the separate processor IC can interface with an application programming interface (API) provided by the network packet switch vendor for the network packet switch IC. This API provides an abstracted programmatic interface with which to apply filter rules to the filter engines within a network packet switch IC to control how packets are forwarded by the packet switch IC within the packet forwarding system 102. As described further below with respect to FIGS. 6A-B, the packet forwarding system can also be implemented as one or more virtual machine (VM) platforms operating within a virtual processing environment hosted by one or more host processing systems.

As described herein, the packet forwarding system 102 automatically implements filters 107 as one or more forwarding rules 108 that are applied to filter engines 109, such as ingress filter engines 506 and egress filter engines 512 in FIG. 5A. The forwarding rules 108 represent the internal device specific representations that are used to implement the filter engine rules. For current packet switch ICs, these device specific representations often include programming or provisioning of filter rules into ternary content-addressable memories (TCAMs) within the packet switch ICs. A filter rule typically includes a predicate and one or more action(s). The predicate is one or more traffic-matching criteria that are logically AND-ed together (e.g., TCAM matching criteria such as VLAN ID or Source IP address). Each predicate compares a key to a value. The key is computed by selecting fields from packets based on protocol and content of the packet. An action can be defined by the filtering rule and applied when a match occurs. For current TCAMs (and packet switch IC filter engines), actions typically include where to forward the packet, whether to drop the packet, and/or other desired action(s) with respect to the packet. For example, additional actions can include adding headers, adding identifiers within headers, stripping headers, stripping identifiers within headers, and/or other additional actions to modify packet contents.

Based upon the applied filter rules 108, the filter engines 109, such as ingress filter engines 506 and egress filter engines 512 in FIG. 5A, conditionally direct traffic from the input ports to the output ports. Filter rules can specify a single traffic-matching criteria or they can involve Boolean expressions that logically combine various traffic-matching criteria to represent the desired filtering behavior. Further, the various criteria in the filter may include ranges and/or non-contiguous lists of values which effectively allow for a second level of OR-ing within the filters. In addition, other logic, such as NOT operations, and/or more complicated logic expressions such as source/destination pairs and bidirectional flows could also be represented in filter rules, if desired. A filter's traffic-matching criteria can be configured as desired. For example, matching criteria can be configured to include values in any ISO (International Standards Organization) OSI network layer 2 (L2) through layer 7 (L7) header value or packet content. It is noted that packet-based communications are often discussed in terms of seven communication layers under the OSI model: application layer (L7), presentation layer (L6), session layer (L5), transport layer (L4), network layer (L3), data link layer (L2), and physical layer (L1). Examples of traffic-matching filter criteria for packet-based communications include but are not limited to:
Layer 2 (L2): Source/Destination MAC address, VLAN, Ethertype
Layer 3 (L3): Source/Destination IP address, IP Protocol, Diffserv/TOS
Layer 4 (L4): Source/Destination L4 Port, TCP Control flags
   It is noted that these L2-L4 criteria are useful because existing hardware designs for packet switch ICs parse these packet headers. However, packet switch devices can be improved by extending filter capabilities to layers 5-7 (L5-L7), and this additional filtering criteria can be used by the packet forwarding system 102 as well.

FIG. 5B is a diagram of an example embodiment for a product configuration as well as external connections for an example packet forwarding system 102. As depicted, the packet forwarding system 102 includes a housing 550 having external connections for a variety of connector types. For example, Ethernet port connectors 552 can be provided (e.g., Ethernet ports 1-24), and fiber optic connectors 554 can be provided for fiber optic connector modules. Further, a display screen, such a back-lit LCD (liquid crystal display) screen 557, can also be included for displaying information related to the packet forwarding system 102. Direct navigation controls 558 can also be included, for example, for navigating management menus displayed in screen 557. Although not shown, a separate management network port can also be provided, for example, on the back of housing 550. This management network port can provide a control and management network interface to control panel 104 for the packet forwarding system 102. It is further noted that circuitry for the packet forwarding system 102, including PCBs and power supply circuitry, can be mounted within the housing 550. Other variations can also be implemented while still taking advantage of the source label embodiments described herein.

As indicated above, the packet forwarding system can also be implemented as one or more virtual machine (VM) platforms within a virtual processing environment hosted by one or more host processing systems. FIGS. 6A-B provide example embodiments of virtual environments. For example, one or more of the components within the network environment 100 of FIG. 1 can be virtualized such that they operate as one or more VM platforms within a virtual environment. Virtual resources can be made available, for example, through processors and/or processing cores associated with one or more server processing systems or platforms (e.g., server blades) used to provide software processing instances or VM platforms within a server processing system. A virtual machine (VM) platform is an emulation of a processing system that is created within software being executed on a VM host hardware system. By creating VM platforms within a VM host hardware system, the processing resources of that VM host hardware system become virtualized for use within the network communication system. The VM platforms can be configured to perform desired functions that emulate one or more processing systems.

FIG. 6A is a block diagram of an example embodiment for a virtual machine (VM) host hardware system 600 that communicates with a network 614 such as a packet network communication system. For the example embodiment depicted, the VM host hardware system 600 includes a central processing unit (CPU) 602 that runs a VM host operating system 620. An interconnect bridge 608 couples the CPU 602 to additional circuitry and devices within the VM host hardware system 600. For example, a system clock 612, a network interface card (NIC) 604, a data storage system 610 (e.g., memory) and other hardware (HAY) 606 are coupled to the CPU 602 through the interconnect bridge 608. The system clock 612 and the storage system 610 can also have a direct connections to the CPU 602. Other hardware elements and variations can also be provided.

The VM host hardware system 600 also includes a hypervisor 622 that executes on top of the VM host operating system (OS) 620. This hypervisor 622 provides a virtualization layer including one or more VM platforms that emulate processing systems, such as the packet forwarding systems described above, and that provide related processing resources. As shown with respect to VM platform that implements a first packet forwarding system 102A, each of the VM platforms 102A, 102B, 102C . . . is configured to have one or more virtual hardware resources associated with it, such as virtualized ports 624A, a virtualized processor 626A, virtualized filter engines 628A, and/or other virtualized resources. The VM host hardware system 600 hosts each of the VM platforms 102A, 102B, 102C . . . and makes their processing resources and results available to the network 618 through the VM host operating system 620 and the hypervisor 622. As such, the hypervisor 622 provides a management and control virtualization interface layer for the VM platforms 102A-C. It is further noted that the VM host operating system 620, the hypervisor 622, the VM platforms 102A-C, and the virtualized hardware resources 624A/626A/628A can be implemented, for example, using computer-readable instructions stored in a non-transitory data storage medium that are accessed and executed by one or more processing devices, such as the CPU 602, to perform the functions for the VM host hardware system 600.

FIG. 6B is a block diagram of an example embodiment for a server system 650 including multiple VM environments 654 and 674 that host VM platforms implementing packet forwarding systems. For the example embodiment 650, a number of processing system platforms 670, such as blade servers that include VM host hardware systems 600 of FIG. 6A, are connected to an external network communication system through connections 651 and to each other through a router or switch 652. For the example embodiment 650, the processing system platforms 670 are configured into three nominal groups as indicated by nodes 671, 673, and 675. The processing system platforms 670 within each group are managed together to provide virtual processing resources as part of the network communication system. For the example embodiment 650, one group 672 of processing system platforms 670 is used to host a VM environment 654 that includes virtual machine (VM) platforms operating to provide packet forwarding systems 102A-1, 102B-1 . . . 102C-1, respectively. One other group 674 of processing system platforms 670 is used to host a VM environment 656 that includes virtual machine (VM) platforms operating to provide packet forwarding systems 102A-2, 102B-2 . . . 102C-2, respectively. It is noted that other groupings of processing system platforms 670 can also be used, or all of the processing system platforms 670 can be managed individually or as a single unit. The VM platforms 102A-1, 102B-1 . . . 102C-1 within VM environment 654 can communicate with each other, with the other VM environment 656, or with other processing systems or virtual environments within server system 650 or the external network. Similarly, the VM platforms 102A-2, 102B-2 . . . 102C-2 within VM environment 656 can communicate with each other, with the other VM environment 654, or with other processing systems or virtual environments within server system 650 or the external network. Further, it is noted that the processing system platforms 670 can be connected to each other by a high-speed communication backbone. Other variations could also be implemented while still taking advantage of the source label techniques described herein.

### EXAMPLES

### Rule Reduction

Example embodiments are now further described with respect to processing of sets of filter parameters or variables set forth in packet filters in order to identify and remove expressions that are not useful in forwarding packets actually received by the packet forwarding system, such as unnecessary expressions and redundant expressions within overlapping conditions and mutually exclusive conditions, before generation of packet forwarding rules for filter engines within a packet forward system.

The example embodiments below are interested in (finite subsets of positive propositional) formulas composed from a set of variable symbols V={x, y, z, . . . }, and Boolean operators of conjunction A or disjunction V, where disjunctions have at least two variables. Standard syntax and semantics are used, with parentheses allowed for grouping. In the following Γ denotes a finite set of propositional formulas and p, q, r, . . . (possibly subscripted) denote formulas. For filter f=(p, A)εF, V(f)⊂V denotes the set of variables appearing in formula p of f. A truth assignment is a function: ε: V→{true, false}, mapping variables into truth values. It is noted that where a filter involves predicates rather than the variables presented here, then any assignment to one of our variables has to be restricted to be compatible with the assignment to the variables of the predicates. In this case, any assignment referred to is a member of this restricted set but no other changes are required. In particular, we will represent the predicates by simple variables in the formulas to reduce the notational complexity. Of course, formulas with predicates are not necessarily satisfiable like positive propositional formulas, so we can examine the formulas to try to detect ones which are not satisfiable.

### Overview—Overlapping Filters and Rules Reduction

Two distinct filters f₁ and f₂ are said to overlap if a (not necessarily minimal) assignment to the variables of f₁ is an assignment to those of f₂. Also, the filter variables may be partitioned into classes, and two filters are said to intersect if their formulas have any variables in the same class. The filter reduction techniques herein reduce filter engine rules for an overlapping set of filters.

In general for n filters, filter engine rules 108 will contain 2ⁿ rules if there is no a reduction of rules. The disclosed embodiments reduce the number of rules that are defined in order to save memory space used to store the resulting rules in filter engines and to reduce the amount of time required to generate the rules. Space optimization is relevant for dedicated hardware, such as switches, because the available memory is often very limited. Reducing the number of filter rules to be generated is also important, such as within a virtual machine processing environments, because the filtering process may be just one of many hundreds of processes competing for system resources and can be viewed negatively if its resource demands affect other processes because of time or space resources required to generate filter rules.

A filter 107 can be represented by: f=(p, A) including a logical formula p, which is either a conjunction or a disjunction of Boolean variables (qualifiers), together with a set A of associated atomic forwarding actions a. The qualifiers of given filter 107 may be evaluated in the context of an input to determine which conditions hold. That is, the qualifiers represent the variables of the formula and the input determines a truth assignment to those variables. For an input, this semantics is extended to a set of filters by evaluating filters individually with a single, fixed assignment for all the variables of the filters. In this case, multiple filters may hold for a given input whether they overlap or not. In the case that no filters apply, the default action is denoted by ⊥.

If P is a set of formulas and A is a set of actions, let R⊂P×A be a rules set, and R* be the set of all finite sequences of elements from R. A rules sequence RεR* can be written R=(r₁, r₂, . . . rₙ) as a linearly ordered set of n≧0 rules rᵢ=(P, A) where P⊂P and A⊂A. R^{M} denotes a minimal rules sequence semantically equivalent to R. The semantics of evaluating a rule for an input is similar to that for a filter. The semantics of evaluating a rule sequence for an input is such that the rules are evaluated individually (e.g., increasing with higher priority numbered first) for an input, and the evaluation terminates at the first (e.g., lowest numbered rule) whose condition p holds for the input.

As described herein, a set of filters 107 are processed to generate a set of rules 108 including a rules sequence such that for any input to the packet forwarding system 102, the forwarding actions defined within the set of filters 107 are implemented within the forwarding actions resulting from the corresponding rule sequence for the rules 108 that are applied to the filter engines 109.

For the embodiments described herein, the rules reduction techniques form all subsets of filters from a set of filters to identify overlapping conditions and perform pairwise comparisons of each filter to other filters within a set of filters to identify mutually exclusive conditions. As further described herein, when overlapping conditions or mutually exclusive conditions are found, unnecessary expressions and redundant expressions are removed to reduce the number of rules to be generated. For each remaining subset or formula, a rule is created where the rule formula p is the conjunction of the formulas from the subset, and A is the union of the action sets from the subset. The rules are then partially ordered by the cardinality of the subset used to construct each rule. This transformation of filter formulas and related parameters to filter rules 108 and related forwarding actions allow for input packets received by the packet forwarding system 102 to be forwarded according to the filter actions defined within the user-defined filters 107. As such, the filter rules 108 provide that the outputs for each filter 107 are implemented as defined and that input (packet) counting statistics are gathered accurately. The rule reduction techniques applied by the rule reduction engine 150 advantageously streamline the number of filter rules 108 that are generated for a given set of filters 107.

### Unnecessary Expressions

If there is no data which can satisfy the conditions of a filter, then we need not include any rule which depends on the formula of that filter. We call this an unnecessary formula. We now consider removing unnecessary formulas.

For set of filters F with subset C(F)⊂F of filters whose conditions are conjunctions of variables, consider filters f=(p, {A})∈C(F) and g=(q, {B})∈C(F) with variables a ∈ [symbol] (p) and b∈ [symbol] (q). In defining the portion of the forwarding rules which will result from filters with conjunctive formulas, subsets of F (such as [symbol] (F)) are considered and suppose one of the subsets contains a formula f [symbol] g. Suppose that for all assignments ε, there are variables a and b as above such that ε [symbol] a [symbol] ε [symbol] b. Then for no assignment would ε [symbol] f [symbol] g be possible since

ε [symbol] f [symbol] g [symbol] ε [symbol] (a,{A}) and ε [symbol] (b,{B}).

So any subset containing a formula with term f [symbol] g need never generate a rule, because it would contain a condition with term a [symbol] b.

It is noted that rather than consider all subsets of F as described in the previous paragraph, we could consider a smaller set defined as follows. For [symbol] (X)={Y|Y⊂X} the powerset of set X, define the set of variable-action pairs [symbol] ̂⊂C(F)×( [symbol] (V)× [symbol] (A)), called subrules, for a filter. For filter f∈C(F), define the subrules we can form by [symbol] ̂(f)={( [symbol] (p), A)|f=(p, A)} with their extension [symbol] ̂(F)==U_{f∈F} [symbol] ̂(f) to a set of filters F. Then for set of filters F, we could use [symbol] (F)⊂V×A, the portion of rules which will result from filters with conjunctive formulas, defined by [symbol] (F)=P( [symbol] ̂(C(F))).

For filters fᵢ, fⱼ ∈C(F), to express the notion that their formulas pᵢ and pⱼ are not both to appear in a subset S used to construct conjunctions, we will write constraint {i, j}∉S, or simply {i, j} when the context S is understood. With an invertible map

b: [symbol] ({i,j})→ [symbol] ({1,2})

we can use r to encode our constraints compactly and usefully. One example map is to extend b({min(i,j)})={1} and b({max(i,j)})={2}.

Given r: [symbol] ( [symbol] ₙ)→{0,1}ⁿ, a ranking function for sets, as we enumerate the elements of {0,1}², we find

b⁻¹(r⁻¹(00))=b⁻¹(ø)=ø

b⁻¹(r⁻¹(01))=b⁻¹({1})={i}

b⁻¹(r⁻¹(10))=b⁻¹({2})={j}

Thus, by enumerating the first 3 elements of {0,1}² (the first 3 numbers in a 2-digit binary representation) we generate all subsets of {i,j} except {i,j}.

Since so far we have only considered construction of conjunctions from sets of filters with conjunctive conditions, the effect of mutually exclusive conditions is described below. Fortunately, the method extends easily to sets of filters with either conjunctive or disjunctive conditions.

For filter f=(p, {A})∈D(F)⊂F with p=t₁ [symbol] . . . [symbol] tⱼ we remove f, introduce j additional filters (tᵢ_{₁}, {A}) . . . , (tᵢ_{ⱼ}, {A}) for unique i₁, . . . iⱼ, and add j(j−1)/2 constraints {iₖ,iₗ} for all 1≦k<l≦j.

### Redundant Expressions

If for some data there is a pre-condition which causes a formula to be satisfied, then we need not include that formula when the pre-condition exists. We call this a redundant formula and consider how to remove them.

Suppose that for all assignments ε, there exist filters f=(p, {A}) and g=(q [symbol] r, {B}) as described above such that ε [symbol] p [symbol] ε [symbol] q. Then

ε [symbol] f [symbol] g [symbol] ε [symbol] (p [symbol] r,{A,B}).

So for any fixed assignment, a subset containing a formula with clause f [symbol] g can contain a simpler formula with p [symbol] r when it would have had p [symbol] q [symbol] r.

### Examples for Identification/Reduction of Overlapping Conditions

### Preliminaries—Overlapping Conditions

The desired orderly generation of combinatorial structure (our subsets or combinations) has the property that it should be possible to obtain the kth structure directly from the number k, and conversely. This is because, though occasionally we are interested in a complete enumeration, our main interest will be in the ability to enumerate a certain number of structures beginning with a particular member, then skip some elements, then enumerate a greater subsequence, and so forth. The origin of this requirement is discussed below.

Given set F of n filters, filters fᵢ, fⱼ∈C(F) with i<j≦n, let {i,j} be the denotation for a constraint with the interpretation that fᵢ [symbol] fⱼ is unnecessary. For graph G=(V, E), define a path to be a sequence of nodes v₁, . . . , vₖ such that for all 0<i<k, (vᵢ,vᵢ₊₁)∈E.

### Rule Reduction—Overlapping Conditions

In the presence of (not necessarily disjoint) constraints C=∪ₖ₌₁^{m}{vᵢ_{ₖ},vⱼ_{ₖ}} (where v is a graph node not formula variable) we are interested in paths which do not violate any constraints. Let graph G be such that

(a,b)∈E if (a,b)∈C.

A path v₁, . . . , vₖ in G is valid if for all 0<i<k, (vᵢ, vᵢ₊₁)∉C. Instead of using G, our method will construct paths in G^{c}, the complement graph of G. Each path v₁, . . . , vₖ of length k in G^{c} is extended to a path v₁, . . . , vₖ, vₖ₊₁ provided (vᵢ,vₖ₊₁)∈E^{c} for all 0<i<k+1. Since paths are built by extension and the constraints can be pre-processed, it is easy to see that validation of the path for an additional node can be done in O(1) for small n using a bit implementation of set operations. So each of the at most

$$( \begin{matrix}n \\ k\end{matrix} )$$

valid sunsets of size k can be constructed in time O(k). Using depth-first traversal and pruning, we can efficiently enumerate only valid paths since we avoid enumerating even minimal invalid paths. Then total time for all valid subsets is less than

$${\sum }_{k} k ( \begin{matrix}n \\ k\end{matrix} ) = n {2}^{n - 1} .$$

Searching for valid subsets using G^{c} allows us to search a smaller space than using a typical recursive enumeration of subsets. This is because G^{c} omits edges corresponding to constraints, that is, edges in

{(i,j)|(i,j)∈E and {i,j}∈C}

whereas a recursive search for subsets only verifies validity afterwards. Both search mechanisms apply similar pruning techniques.

### Rule Production—Overlapping Conditions

For a set of filters F, select an enumeration of the subsets of F containing filters with conjunctive formulas. For maximum efficiency, we might select an enumeration of [symbol] (F). As indicated above, it is again noted that rather than consider all subsets of F, we could consider a smaller set defined as follows. For [symbol] (X)={Y|Y⊂X} the powerset of set X, define the set of variable-action pairs [symbol] ̂⊂C(F)×( [symbol] (V)× [symbol] (A)), called subrules, for a filter. For filter f∈C(F), define the subrules we can form by [symbol] ̂(f)={( [symbol] (p), A)|f=(p,A)} with their extension [symbol] ̂(F)=∪_{f∈F} [symbol] ̂(f) to a set of filters F. Then for set of filters F, we could use [symbol] (F)⊂V×A, the portion of rules which will result from filters with conjunctive formulas, defined by [symbol] (F)= [symbol] ( [symbol] ̂(C(F))). But for this exposition, without loss of generality, we will use the simpler enumeration of the elements of [symbol] (C(F)), the powerset of C(F).

For subset S∈ [symbol] (C(F)), S={f₁, f₂, . . . , fₖ}, where fᵢ=(pᵢ,{Aᵢ}), we generate rule

(p₂ [symbol] p₂ [symbol] . . . [symbol] pₖ,{A₁,A₂, . . . ,Aₖ})

if p₁ [symbol] p₂ [symbol] . . . [symbol] pₖ is not unnecessary.

This can be done efficiently for each rule if the subsets are enumerated in reverse lexicographic order. Memorization is used to save results of previous subsets, carefully recycling unneeded storage when the subset size changes. Given whether fᵢ [symbol] fⱼ is unnecessary for each pair in F, memorization can be used to record for subset S={f₁, . . . , fₖ} whether f₁ [symbol] . . . [symbol] fₖ is unnecessary to be used in the computation for larger subsets.

### Reduction Examples—Overlapping Conditions

It is possible to determine the space reduction in the size of the filter rules by identifying and removing unnecessary and redundant expressions. It is further noted that that the savings from removing redundant expressions may decrease the space for a set of rules but often will not reduce the number of rules with the set. For example, given set S and set T consisting of m pairwise disjoint 2-element subsets of S, the fraction of the subsets of S which do not have a member of T as a subset is (¾)^{m}. The examples A1 and A2 below provide an application of this reduction.

### Example Rule Reduction (A1)—Overlapping Conditions

In this example we show the effect of overlapping formulas and their elimination from the rule set when possible. Let the variables of the formulas be a₁¹, a₂¹, a₂², a₃², . . . , a₁₉¹⁹, a₂₀¹⁹ where the superscript denotes the class to which a variable belongs. We arrange for unnecessary formulas by defining all assignments E such that for 0<m<20

a. ε [symbol] aₘ₊₁^{m};

b. ε [symbol] aₘ^{m}.

Now consider the following formulas:

$$1. {a}_{1}^{1}$$

$$2. {a}_{2}^{1} ⋀ {a}_{2}^{2}$$

$$3. {a}_{2}^{1} ⋀ {a}_{3}^{2} ⋀ {a}_{3}^{3}$$

$$4. {a}_{2}^{1} ⋀ {a}_{3}^{2} ⋀ {a}_{4}^{3} ⋀ {a}_{4}^{4}$$

$$…$$

$$19. {a}_{2}^{1} ⋀ {a}_{3}^{2} ⋀ {a}_{4}^{3} ⋀ {a}_{5}^{4} ⋀ … ⋀ {a}_{19}^{19}$$

$$20. {a}_{2}^{1} ⋀ {a}_{3}^{2} ⋀ {a}_{4}^{3} ⋀ {a}_{5}^{4} ⋀ … ⋀ {a}_{20}^{19}$$

Formula m>0 in conjunction with any formula n>m yields an unnecessary formula since the conjunction is a contradiction by conditions a and b. By construction aₘ^{m} is a term of formula m and aₘ₊₁^{m} is a term of formula n>m. But for all assignments ε,

ε [symbol] aₘ^{m} and ε [symbol] aₘ₊₁^{m}.

Thus, of the 2²⁰ subsets of these formulas as conjunctions, only the 20 singletons are not unnecessary. The method described herein produces only these 20 rules while the existing method produces 2²⁰ truth tables and rules.

### Example Rule Reduction (A2)—Overlapping Conditions

Using the notation introduced above, consider the following formulas:

$${a}_{1}^{1} ⋀ {a}_{1}^{2}$$

$${a}_{2}^{2} ⋀ {a}_{1}^{3}$$

$${a}_{1}^{4} ⋀ {a}_{1}^{5}$$

$${a}_{2}^{5} ⋀ {a}_{1}^{6}$$

$$…$$

$${a}_{1}^{16} ⋀ {a}_{1}^{17}$$

$${a}_{2}^{17} ⋀ {a}_{1}^{18}$$

$${a}_{1}^{19} ⋀ {a}_{1}^{20}$$

$${a}_{2}^{20} ⋀ {a}_{1}^{21}$$

Of the 2¹⁴ subsets of these formulas as conjunctions, only 3⁷ are necessary. The method described herein produces only these 2187 rules while the prior method produces 16384 truth tables and rules.

### Example Rule Reduction (B1)—Overlapping Conditions

In this example we show the effect of overlapping formulas, both conjunctions and disjunctions, and their elimination from the rule set when possible. Let the variables a₁, . . . , a₂₀ of the formulas belong to a single class and variable b another. We arrange for unnecessary formulas by defining all assignments E such that there exists some i such that for all j≠i,

ε [symbol] aᵢ [symbol] ε [symbol] aⱼ.

Now consider the following formulas:

$$1. {a}_{1} ⋀ b$$

$$2. {a}_{2} ⋀ b$$

$$…$$

$$20. {a}_{20} ⋀ b$$

$$21. {a}_{1} ⋁ {a}_{2}$$

$$22. {a}_{3} ⋁ {a}_{4}$$

$$…$$

$$30. {a}_{19} ⋁ {a}_{20}$$

First, consider formulas 1 through 20. As indicated above, formula m, 1≦m≦20, in conjunction with any formula n, 1≦n≦20, n≠m, yields an unnecessary formula since the conjunction is a contradiction by construction because aₘ is a term of formula m and aₙ, n≠m, is a term of formula n. But for all assignments E, given such m, n

ε [symbol] aₘ and ε [symbol] aₙ so ε [symbol] aₘ [symbol] aₙ.

Thus, of the 2²⁰ subsets of formulas 1-20 as conjunctions, only the 20 singletons are not unnecessary.

Next, consider the effect of disjunctions 21 through 30. Let aᵢ be a term of formula m, 21≦m≦30, for some i. Suppose aᵢ is combined in a conjunction with any formula n, 1≦n≦20. If i=n, as indicated above, aᵢ is redundant and need not be added to formula n, though the action sets are combined. If i≠n, as indicated above, the resulting formula is unnecessary and can be ignored. Finally, if aᵢ is combined in a conjunction with any distinct term from formula 21≦m≦30, again the resulting conjunction will be unnecessary.

Considered individually as singleton sets of formulas, formulas 1-20 contribute 20 rules (one for each formula) with their action sets and formulas 21-30 contribute another 20 rules (one for each variable) with their action sets. Finally, each variable of formulas 21-30 will combine with a unique formula 1-20 to produce conjunctions for 20 rules with the union of their action sets. All together, the disclosed method produces only 60 rules while the prior method produces 2²⁰·3¹⁰=61,917,364,224 truth tables and rules.

### Examples for Identification/Reduction of Mutually Exclusive Conditions

### Preliminaries—Mutually Exclusive Conditions

The desired orderly generation of combinatorial structure (our subsets or combinations) has the property that it should be possible to obtain the kth structure directly from the number k, and conversely. This is because, though occasionally we are interested in a complete enumeration, our main interest will be in the ability to enumerate a certain number of structures beginning with a particular member, then skip some elements, then enumerate a greater subsequence, and so forth. The origin of this requirement is discussed below.

Considering now a combinatorial structure, for set S⊂ [symbol] ₙ, define the characteristic function by

$${ϰ}_{S} ( i ) = \{ \begin{matrix}1 , & i ∈ S \\ 0 , & i ∉ S\end{matrix} .$$

Next, we extend the characteristic function to define an encode function r: [symbol] ( [symbol] ₙ)→{0,1}ⁿ. For set S⊂ [symbol] ₙ, let

r(S)=X_{S}(1)· . . . ·X_{S}(n)

which is an encoding of the members of set S using the n digits of the binary representation of values between 1 and 2ⁿ. For [symbol] ₆, some examples are

r({1,2,3,4,5,6})=111111,

r({1,3,5})=101010,

And

r(Ø)=000000.

Note that the inverse r⁻¹:{0,1}ⁿ> [symbol] ( [symbol] ₙ) is simple as well. We extend the domain of r to [symbol] ( [symbol] ( [symbol] ₙ)) and r⁻¹ to [symbol] ({0,1}ⁿ) by union in the obvious manner. Finally, given set X, X⊂ [symbol] (X), and [symbol] ⊂ [symbol] (X), we introduce operator

[symbol]

[symbol]

(X, [symbol] )={X∪Y|X∈X and Y∈ [symbol] }.

Note the close relationship between members of sets formed using U on m sets and points on an m-dimensional rectangle.

### Rule Reduction—Mutually Exclusive Conditions

Given set F of n filters, filters fᵢ, fⱼ∈F with i<j≦n, let {i,j} be the denotation for a constraint with the interpretation that fᵢ [symbol] fⱼ is unnecessary. As mentioned, our goal is not just to find all subsets S⊂ [symbol] ₙ such that {i,j} [symbol] S, but to enumerate them in an efficient manner. Listing all subsets and then checking the above condition is not efficient enough for our purposes. As shown above with respect to Examples A1, A2, and B1 above, sets of n formulas can be generated such that of the 2ⁿ subsets, only O(n) produce satisfiable conjunctions.

Recall that the length of a path is the number of nodes on the path. Given n>0 and m≦n/2 constraints, {i₁, j₁}, . . . , {iₘ,jₘ} defining G^{c}, enumerate exactly the subsets of [symbol] ₙ, not including any of the constraints.
for each a: [symbol] ( [symbol] ₙ,\∪ₖ₌₁^{m}{{iₖ}, {jₖ}})
   for each b: set of nodes on valid paths in G^{c}
      output a ∪b

Note that the set operations can be efficiently implemented by iterating over the n-digit binary representation of the set and using bit-wise or. In that case the result becomes

output r⁻¹(a or r(b⁻¹(r⁻¹(b))))=output r⁻¹(a)∪b⁻¹(r⁻¹(b))

where a and b are the binary representations of a and b, and r is a ranking function for sets.

### Reduction Examples—Mutually Exclusive Conditions

It is possible to determine the space reduction in the size of the filter rules by identifying and removing unnecessary and redundant expressions. It is further noted that that the savings from removing redundant expressions may decrease the space for a set of rules but often will not reduce the number of rules with the set.

### Example Rule Reduction (C1)—Mutually Exclusive Conditions

Suppose for n=6, we have disjoint constraints {1, 2}, {3, 4}, and {5, 6}. The edges E of the complement graph G^{c} are
(1, 3), (1, 4), (1, 5), (1, 6),
(2, 3), (2, 4), (2, 5), (2, 6),
(3, 5), (3, 6),
(4, 5), (4, 6).

We list next the sets of vertices on valid paths of length ≦6.

| Path length: | Sets |
|---|---|
| 0: | ø |
| 1: | {1}, {2}, {3}, {4}, {5}, {6} |
| 2: | {1, 3}, {1, 4}, {1, 5}, {1, 6} |
| | {2, 3}, {2, 4}, {2, 5}, {2, 6} |
| | {3, 5}, {3, 6} |
| | {4, 5}, {4, 6} |
| 3: | {1, 3, 5}, {1, 3, 6}, {1, 4, 5}, {1, 4, 6} |
| | {2, 3, 5}, {2, 3, 6}, {2, 4, 5}, {2, 4, 6}. |

Since there are 3 disjoint constraints, we expect (¾)³·2⁶=3³=27 sets which do not violate a constraint, exactly the number produced. It can also be verified that the correct sets were omitted.

### Example Rule Reduction (C2)—Mutually Exclusive Conditions

Suppose for n=5, we have non-disjoint constraints {1, 2}, {1, 3}, {1, 4}, {2, 4}, {2, 5}, and {3, 5}. The edges E of the complement graph G^{c} are
(1, 5), (2, 3), (3, 4), and (4, 5).

We list next the sets of vertices on valid paths of length ≦5.

| Path length: | Sets |
|---|---|
| 0: | ø |
| 1: | {1}, {2}, {3}, {4}, {5} |
| 2: | {1, 5}, {2, 3}, {3, 4}, {4, 5}. |

It can also be verified that the correct sets are omitted.

### Example Rule Reduction (C3)—Mutually Exclusive Conditions

Suppose for n=20, we have non-disjoint constraints
{1, 2}, {1, 3}, . . . , {1, 20}, {2, 3}, {2, 4}, . . . , {2, 20}, . . . , {18, 19}, . . . , {18, 20}, and {19, 20}.

Here we have the extreme case where the complement graph G^{c} has edge set E=Ø and so the sets of nodes on valid paths consist only of those for paths of length 0 and 1.

Thus, of the 2²⁰ subsets of these formulas as conjunctions, only the 20 singletons are not unnecessary. The disclosed method therefore produces only these 20 rules while the prior method produces 2²⁰ truth tables and rules.

### Example Rule Reduction (C4)—Mutually Exclusive Conditions

This example presents an application of the method to a set of formulas including conjunctions and disjunctions, both with mutually exclusive conditions. Using our previous notation, aⱼⁱ, for instance j of variable a of class i, suppose for n=2 we have formulas

$$1 \text{:} {a}_{1}^{1} ⋀ {a}_{1}^{2}$$

$$2 \text{:} {a}_{2}^{1} ⋁ {a}_{2}^{2} ⋁ {a}_{1}^{3} .$$

Using the transformation described above, the original system with formulas 1 and 2 becomes a modified system with the removal of formula 2 and the introduction of the 3 formulas 2′-4′ below, and corresponding constraints. This gives a new system in which n′=4, the formulas are

$${1}^{′} \text{:} {a}_{1}^{1} ⋀ {a}_{1}^{2}$$

$${2}^{′} \text{:} {a}_{2}^{1}$$

$${3}^{′} \text{:} {a}_{2}^{2}$$

$${4}^{′} \text{:} {a}_{1}^{3} ,$$

and with constraints {1′, 2′}, {1′, 3′}, {2′, 3′}, {2′, 4′}, and {3′, 4′}. These determine the edges of G and (1′, 4′) is the only edge of the complement graph G′.

We list next the sets of vertices on valid paths of length ≦4.

| Path length: | Sets |
|---|---|
| 0: | ø |
| 1: | {1′}, {2′}, {3′}, {4′} |
| 2: | {1′, 4′}. |

We can verify that the original formulas yield formula a₁¹ [symbol] a₁² [symbol] a₁³ as the only not unnecessary combination of two formulas, plus the singletons and empty set. This conjunction is the one produced by path length 2 in G^{c} and is described by node set {1′, 4′}, the conjunction of formulas 1′ and 4′.

### Example Rule Reduction (D1)—Mutually Exclusive Conditions

Suppose for n=4, we have constraint {1, 3}.
for each a: [symbol] ( [symbol] ₄†{1,3})
   for each b: {Ø,{1}, {3}}
      output a∪b
a=Ø
   b=Ø
      output Ø
   b={3}
      output {3}
   b={1}
      output {1}
a={4}
   b=Ø
      output {4}
   b={3}
      output {3,4}
   b={1}
      output {1,4}
a={2}
   b=Ø
      output {2}
   b={3}
      output {2,3}
   b={1}
      output {1,2}
a={2,4}
   b=Ø
      output {2,4}
   b={3}
      output {2,3,4}
   b={1}
      output {1,2,4}

As desired, sets {1, 3}, {1, 2, 3}, {1, 3, 4}, and {1, 2,3, 4} are exactly those omitted.

It is noted that the operational blocks described herein can be implemented using hardware, software or a combination of hardware and software, as desired. In addition, integrated circuits, discrete circuits or a combination of discrete and integrated circuits can be used, as desired, that are configured to perform the functionality described. Further, programmable integrated circuitry can also be used, such as FPGAs (field programmable gate arrays), ASICs (application specific integrated circuits), and/or other programmable integrated circuitry. In addition, one or more processors running software or firmware could also be used, as desired. For example, computer readable instructions embodied in a tangible medium (e.g., memory storage devices, FLASH memory, random access memory, read only memory, programmable memory devices, reprogrammable storage devices, hard drives, floppy disks, DVDs, CD-ROMs, and/or any other tangible storage medium) could be utilized including instructions that cause computer systems, programmable circuitry (e.g., FPGAs), and/or processors to perform the processes, functions, and capabilities described herein. It is further understood, therefore, that one or more of the tasks, functions, or methodologies described herein may be implemented, for example, as software or firmware and/or other instructions embodied in one or more non-transitory tangible computer readable mediums that are executed by a CPU, controller, microcontroller, processor, microprocessor, or other suitable processing device.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A method to control forwarding of network packets, comprising:
storing a plurality of filters within a packet forwarding system, each filter being configured to determine how packets are forwarded by the packet forwarding system;
processing the filters to identify overlapping conditions and mutually exclusive conditions;
removing, when overlapping conditions or mutually exclusive conditions are found, unnecessary expressions and redundant expressions to form a set of reduced filter expressions for the plurality of filters;
generating rules for one or more filter engines based upon the set of reduced filter expressions for the plurality of filters;
applying the rules to the one or more filter engines within the packet forwarding system;
receiving packets from a network using the packet forwarding system; and
forwarding the received packets using the filter engines within the packet forwarding system so that packets are forwarded based upon the plurality of filters.

2. The method of claim 1, wherein the processing comprises generating subsets of filters based upon the plurality of filters and analyzing each subset of filters to identify duplicated filter expressions.

3. The method of claim 2, further comprising, for each subset of filters, removing duplicated filter expressions as redundant expressions.

4. The method of claim 3, further comprising generating rules for each subset of filters after duplicated filter expressions are identified and removed as redundant expressions.

5. The method of claim 1, wherein the processing comprises, for each of the plurality of filters, pairwise comparing the filter to each of the other filters to identify filter expression contradictions.

6. The method of claim 5, further comprising, for each filter, saving the filter to a reduced set of filters if no filter expression contradictions were identified from the pairwise comparison.

7. The method of claim 6, further comprising generating rules for the reduced set of filters once all filters have been pairwise compared.

8. The method of claim 1, further comprising allowing user configuration of the plurality of filters through a user interface.

9. The method of claim 1, further comprising receiving packets from one or more network sources coupled to one or more input ports for the packet forwarding system, forwarding packets within the packet forwarding system from the one or more input ports to one or more output ports using the one or more filter engines, and forwarding packets from one or more output ports for the packet forwarding system to one or more network destinations.

10. The method of claim 1, wherein the one or more filter engines comprise one or more ingress filter engines associated with input ports for the packet forwarding system and one or more egress filter engines associated with output ports for the packet forwarding system.

11. A packet forwarding system for network packets, comprising:
a plurality of input ports to receive network packets;
a plurality of output ports to output network packets;
a plurality of filter engines that determine how network packets are forwarded from the input ports to the output ports within the packet forwarding system based upon filter engine rules;
a plurality of filters to define how packets from the input ports are to be forwarded to the output ports; and
a filter processor to receive the plurality of filters and to process the filters to identify overlapping conditions and mutually exclusive conditions; to remove, when overlapping conditions or mutually exclusive conditions are found, unnecessary expressions and redundant expressions to form a set of reduced filter expressions for the plurality of filters; to generate the filter engine rules for the filter engines based upon the filters; and to apply the rules to the filter engines.

12. The packet forwarding system of claim 11, wherein the filter processor is configured to generate subsets of filters based upon the plurality of filters and to identify duplicated filter expressions for each subset of filters.

13. The packet forwarding system of claim 12, wherein the filter processor is further configured, for each subset of filters, to remove duplicated filter expressions as redundant expressions.

14. The packet forwarding system of claim 13, wherein the filter processor is further configured to generate rules for each subset of filters after duplicated filter expressions are identified and removed as redundant expressions.

15. The packet forwarding system of claim 11, wherein the filter processor is further configured, for each of the plurality of filters, to pairwise compare the filter to each of the other filters and to identify filter expression contradictions between the filters.

16. The packet forwarding system of claim 15, wherein the filter processor is further configured, for each filter, to save the filter to a reduced set of filters if no filter expression contradictions were identified for the filter from the pairwise comparison.

17. The packet forwarding system of claim 16, wherein the filter processor is further configured to generate rules for the reduced set of filters once all filters have been pairwise compared.

18. The packet forwarding system of claim 11, further comprising a user interface for the packet forwarding system to allow configuration of the plurality of filters.

19. The packet forwarding system of claim 11, wherein the one or more filter engines comprise one or more ingress filter engines associated with input ports for the packet forwarding system and one or more egress filter engines associated with output ports for the packet forwarding system.

20. The packet forwarding system of claim 11, wherein at least one of the filter processor or the plurality of filter engines comprises one or more virtual machines operating within a virtual processing environment.
